(19) United States
(12) Patent Application Publication
(10) Pub. No.: US 2024/0207979 A1
(43) Pub. Date: Jun. 27, 2024

(54) LASER MACHINING APPARATUS

(71) Applicant: HONDA MOTOR CO., LTD., Tokyo (JP)

(72) Inventors: Taisei WAKISAKA, Tokyo (JP); Keiji OTSUKA, Tokyo (JP)

(21) Appl. No.: 18/391,659

(22) Filed: Dec. 21, 2023

(30) Foreign Application Priority Data
Dec. 26, 2022 (CN) 202211678327.5

(51) Int. Cl. B23K 26/70; B23K 26/03; B23K 26/08; B23K 26/36

(52) U.S. Cl. CPC B23K 26/705; B23K 26/03; B23K 26/0823; B23K 26/36

(57) ABSTRACT

To allow even a minute deviation of laser light to be detected and the form and direction of the deviation to be estimated. A laser machining apparatus includes a plate, a meter, a plate drive, and a transition detector. The plate is rotatable and irradiated with the laser light. A through hole is formed at a position spaced apart from the rotation axis of the plate. At least a part of the through hole is included in an irradiation area of the laser light. The through hole allows a part of the laser light to pass therethrough. The meter measures a passing laser amount as an amount of light or an amount of heat of the laser light passing through the through hole. The plate drive rotates the plate. The transition detector detects a transition of a measured value of the passing laser amount as the plate rotates.

This application is based on and claims the benefit of priority from Chinese Patent Application No. CN202211678327.5, filed on 26 Dec. 2022, the content of which is incorporated herein by reference.

### BACKGROUND OF THE INVENTION

### Field of the Invention

The present invention relates to a laser machining apparatus for emitting laser light.

### Related Art

In laser machining by a robot or the like, in many cases, checking whether there is a deviation in the laser irradiation position is visually performed by the operator. Specifically, a sheet with a guideline is set at an irradiation position, and laser light is irradiated toward the guideline. Then, the operator visually checked whether there was any deviation in the irradiation position based on the deviation of the burn mark from the guideline.

This increases the number of inspection man-hours, which is time-consuming, and requires skill on the part of the operator. In addition, since the deviation of the burn mark from the guideline is visually checked, the inspection accuracy is not high.

Therefore, the following technique has been proposed. That is, two plates each having a through hole penetrating in the vertical direction are arranged at an interval in the vertical direction, and laser light is irradiated downward from directly above the upper plate, focusing on the midpoint between the through holes in the upper and lower plates. If the laser light passes through the upper and lower through holes without interfering with any of the edges, it is determined to be normal. On the other hand, if the laser light interferes with at least one edge of the upper or lower through hole and the amount of light passing through decreases, it is determined that at least one of the focal point or the irradiation direction has deviated.

Patent Document 1: Japanese Patent No. 5741417

### SUMMARY OF THE INVENTION

In such a technique, the present inventors have noted the following issues. That is, the density of the light in the irradiation area is normally distributed in the diameter direction of the irradiation area. Therefore, the density of the light decreases toward the edge of the irradiation area. Therefore, even if the laser light interferes with the edge of the through hole, the ratio of the decrease in the total amount of light passing through the through hole is small. Thus, it is difficult to detect a minute deviation of the laser light. In addition, even if a decrease in the amount of light is detected, it is not known whether the laser light is, for example, positionally deviated, angularly deviated, or focally deviated, or in which direction the laser light is deviated. That is, the form and direction of the deviation is not known.

In response to the above issues, an object of the present invention is to allow even a minute deviation of laser light to be detected and the form and direction of the deviation to be estimated.

The present inventors have found that when a through hole for allowing only a part of laser light to pass therethrough is provided in a plate and the plate is rotated, even a minute deviation of the laser light can be detected and the form and direction of the deviation can be estimated, and reached the present invention. The present invention relates to a laser machining apparatus having the following configurations of a first aspect to an eighth aspect.

(1) The first aspect provides a laser machining apparatus including an irradiator, a plate, a meter, a plate drive, and a transition detector. The irradiator is configured to emit laser light. The plate is configured to be rotatable about a predetermined rotation axis and be irradiated with the laser light. The plate includes a through hole at a position spaced apart from the rotation axis. At least a part of the through hole is included in an irradiation area of the laser light in a predetermined normal state. The through hole allows a part of the laser light to pass therethrough. The meter is configured to measure a passing laser amount as an amount of light or an amount of heat of the laser light passing through the through hole. The plate drive is configured to rotate the plate in a state where the plate is irradiated with the laser light. The transition detector is configured to detect a transition of a measured value of the passing laser amount as the plate rotates.

According to this configuration, the through hole allows a part of the laser light from the irradiator to pass therethrough. Therefore, when the irradiation area of the laser light deviates from the normal state, the measured value of the passing laser amount of this configuration may largely change as compared with the case where the through hole allows the whole laser light to pass therethrough. Therefore, even a minute deviation of the laser light can be easily detected.

In addition, the transition detector detects a transition of a measured value of the passing laser amount as the plate rotates. From this transition, it is possible to estimate the form of the deviation of the laser light, such as a positional deviation, an angular deviation, and a focal deviation, and in which direction the laser light has deviated.

As described above, according to this configuration, even a minute deviation of the laser light can be detected, and the form and direction of the deviation can be estimated.

(2) In the second aspect according to the first aspect, one of a plurality of the plates different from each other in at least one of penetrating direction length, shape, or number of the through holes is replaceably provided to the plate drive.

According to this configuration, at least one of the length, shape, or number of the through holes can be changed by replacing the plate. This makes it easier to understand the form and direction of the deviation of the laser light in more detail.

(3) In the third aspect according to the first or second aspect, the plate includes a plurality of the through holes different from each other in at least one of penetrating direction length, shape, or distance from the rotation axis.

According to this configuration, by performing the measurement using the plate in which the plurality of through holes different from each other are formed, it is possible to understand the form and direction of the deviation of the laser light in detail without replacing the plate.

(4) In the fourth aspect according to the first or second aspect, a coating for suppressing reflection of the laser light is applied to an inner peripheral surface of the through hole.

According to this configuration, the reflection of the laser light on the inner peripheral surface of the through hole is suppressed, whereby the laser light interfering with the inner peripheral surface of the through hole can be suppressed from being reflected and passing through the through hole. This makes it possible to understand a minute deviation of the laser light more accurately.

(5) In the fifth aspect according to the first or second aspect, the transition detector detects a direction of positional deviation of the irradiation area from the normal state based on the transition of the measured value.

When the irradiation area is positionally deviated from the normal state, the measured value becomes largest at the rotation angle at which the through hole is closest to the optical axis of the laser light, and the measured value becomes smallest at the rotation angle at which the through hole is most distant from the optical axis of the laser light. Using these events, the direction of positional deviation of the irradiation area from the normal state can be detected.

(6) In the sixth aspect according to the first or second aspect, the transition detector determines that a focal point of the laser light deviates from the normal state on condition that the measured value deviates from the normal state and a change in the measured value as the plate rotates is equal to or less than a predetermined value.

When the focal point of the laser light deviates from the normal state, although the measured value deviates from the normal state, the measured value does not change as the plate rotates. Using these events, it is possible to determine that the focal point of the laser light deviates from the normal state.

(7) In the seventh aspect according to the first or second aspect, the transition detector determines that an angle of an optical axis of the laser light deviates from the normal state on condition that a difference between the measured values when penetrating direction lengths of the through holes are different is equal to or greater than a predetermined value.

In the case where the direction of the optical axis of the laser light deviates from the penetrating direction of the through hole, when the penetrating direction length of the through hole is long, the interference of the laser light with the inner peripheral surface of the through hole is larger than when the penetrating direction length of the through hole is short, whereby the passing laser amount becomes smaller. On the other hand, when the penetrating direction length of the through hole is short, the interference of the laser light with the inner peripheral surface of the through hole is smaller than when the penetrating direction length of the through hole is long, whereby the passing laser amount becomes larger. In other words, in the case where the direction of the optical axis of the laser light deviates from the penetrating direction of the through hole, if the penetrating direction length of the through hole is different, the passing laser amount changes. On the other hand, when the direction of the optical axis of the laser light coincides with the penetrating direction of the through hole, even if the penetrating direction length of the through hole is different, the passing laser amount is not significantly affected. Using these events, it is possible to determine whether the angle of the optical axis of the laser light deviates from the normal state.

(8) In the eighth aspect according to the first or second aspect, the plate includes the through hole having a length in a predetermined longitudinal direction and a length in a lateral direction orthogonal to the longitudinal direction different from each other when viewed in a direction perpendicular to a surface of the plate. The transition detector detects a direction of inclination of an optical axis of the laser light from the normal state based on the transition of the measured value.

At a rotation angle at which the inclination direction of the laser light coincides with the shorter direction of the through hole, the interference of the laser light with the inner peripheral surface of the through hole is larger than at a rotation angle at which the inclination direction of the laser light coincides with the longer direction, whereby the passing laser amount is reduced. On the other hand, at a rotation angle at which the inclination direction of the laser light coincides with the longer direction of the through hole, the interference of the laser light with the inner peripheral surface of the through hole is suppressed as compared with a rotation angle at which the inclination direction of the laser light coincides with the shorter direction, whereby the passing laser amount is increased. Using these events, the direction of the inclination of the laser light can be detected.

As described above, according to the configuration of the first aspect, even a minute deviation of the laser light can be detected, and the form and direction of the deviation can be estimated. Furthermore, according to the configurations of the second to eighth aspects, which cite the first aspect, respective additional effects can be obtained.

### BRIEF DESCRIPTION OF THE DRAWINGS

FIG. 1 is a configuration diagram showing a laser machining apparatus according to the present embodiment;

FIG. 2 is a plan view showing a first plate;

FIG. 3 is a sectional view taken along line III-III shown in FIG. 2;

FIG. 4 is a plan view showing a second plate;

FIG. 5 is a sectional view taken along line V-V shown in FIG. 4;

FIG. 6 is a plan view showing a third plate;

FIG. 7 is a sectional view taken along line VII-VII shown in FIG. 6;

FIG. 8 is a plan view showing a fourth plate;

FIG. 9 is a sectional view taken along line IX-IX shown in FIG. 8;

FIG. 10 is a plan view showing a normal state;

FIG. 11 is a sectional view taken along line XI-XI in FIG. 10;

FIG. 12 is a graph showing the transition of a measured value in the normal state;

FIG. 13 is a plan view showing a state of positional deviation;

FIG. 14 is a sectional view taken along line XIV-XIV shown in FIG. 13;

FIG. 15 is a graph showing the transition of the measured value in the state of positional deviation;

FIG. 16 is a plan view showing a state of focal deviation;

FIG. 17 is a sectional view taken along line XVII-XVII shown in FIG. 16;

FIG. 18 is a graph showing the transition of the measured value in the state of focal deviation;

FIG. 19 is a plan view showing a state of angular deviation when a through hole is circular;

FIG. 20 is a sectional view taken along line XX-XX in FIG. 16;

FIG. 21 is a graph showing the transition of the measured value in the state of angular deviation;

FIG. 22 is a plan view showing a state of angular deviation when a through hole is elliptical;

FIG. 23 is a sectional view taken along line XXIII-XXIII shown in FIG. 22;

FIG. 24 is a graph showing the transition of the measured value in the state of angular deviation;

FIG. 25 is a front sectional view showing a state of positional deviation in a comparative example; and

FIG. 26 is a front sectional view showing a state of positional deviation in the present embodiment.

### DETAILED DESCRIPTION OF THE INVENTION

Hereinafter, embodiments of the present invention will be described with reference to the drawings. However, the present invention is not limited to the following embodiments, and can be modified as appropriate without departing from the gist of the present invention.

### First Embodiment

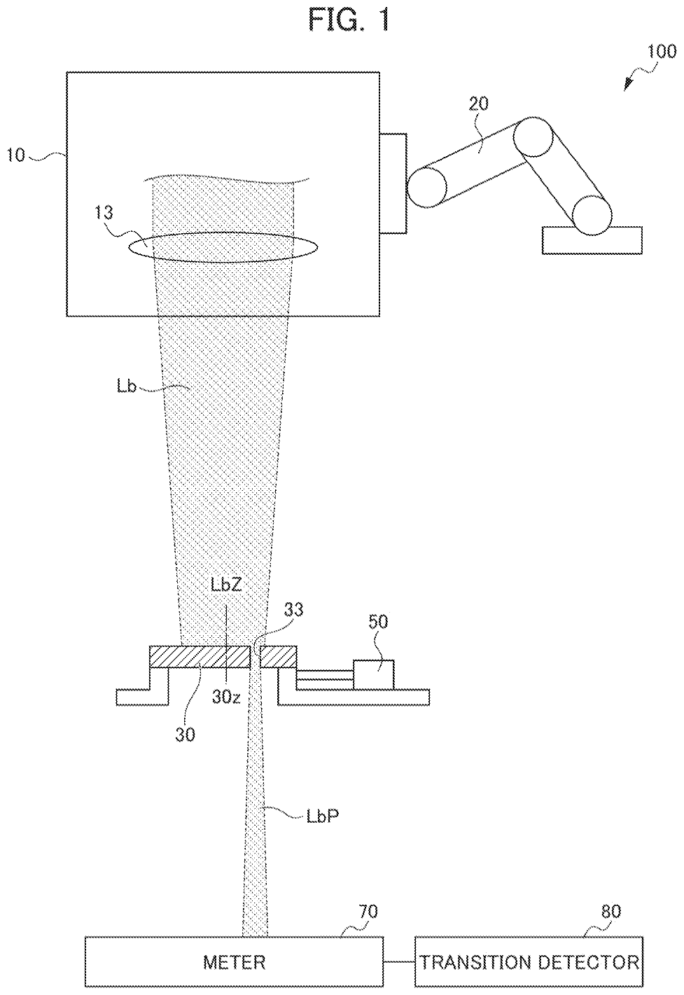

A laser machining apparatus 100 shown in FIG. 1 is an apparatus for performing laser machining on a workpiece, and includes an irradiator 10 and an arm 20. The irradiator 10 includes a condensing lens 13, and emits laser light Lb while condensing the laser light Lb with the condensing lens 13. The arm 20 is configured to be able to move the irradiator 10. Hereinafter, the center line of the laser light Lb is referred to as an “optical axis LbZ”, and a desired state of the laser light Lb is referred to as a “normal state”.

The laser machining apparatus 100 includes a plate 30, a plate drive 50, a meter 70, and a transition detector 80 as parts for detecting a deviation of the laser light Lb from the normal state. Hereinafter, a direction perpendicular to a surface of the plate 30 is referred to as a “plate normal direction”.

The rotor of the plate drive 50 supports one of a plurality of plates 30 so as to be rotatable about a predetermined rotation axis 30z extending in a vertical direction, with the plate normal direction being the vertical direction. The arm 20 is configured to be able to dispose the irradiator 10 above the plate 30. Hereinafter, the surface of the plate 30 on the side of the irradiator 10 is referred to as a “front surface”, and a surface opposite thereto is referred to as a “back surface”.

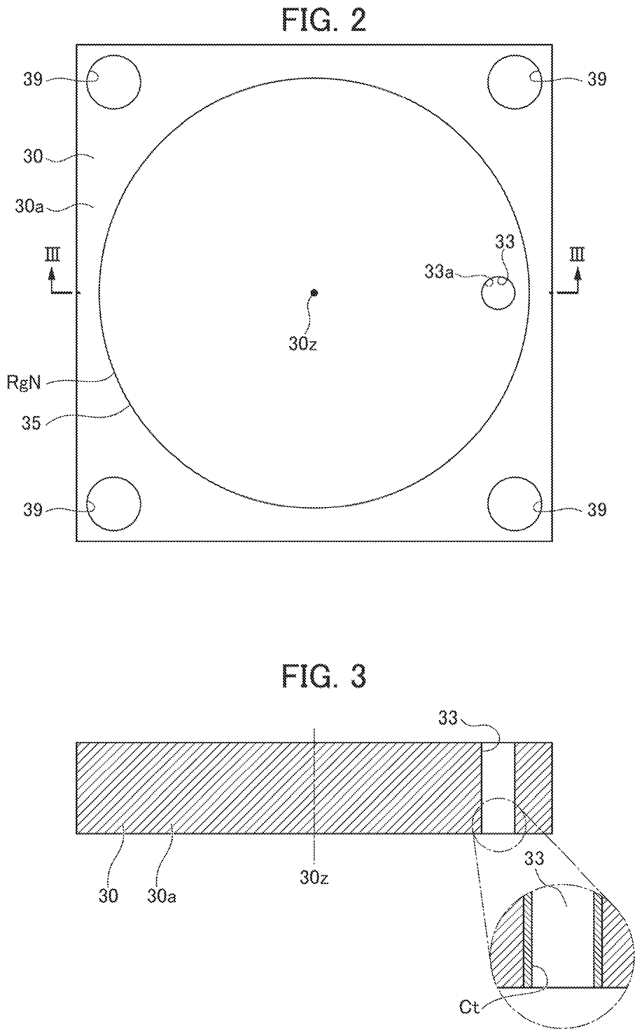

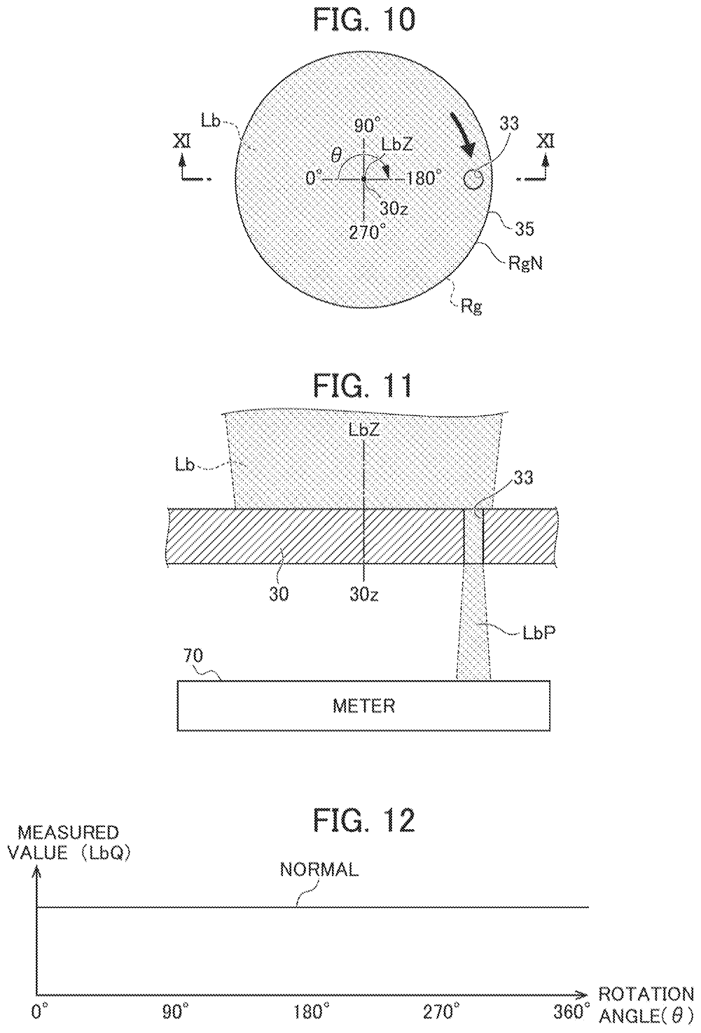

As shown in FIG. 2, the plate 30 has a rectangular shape when viewed in the plate normal direction. Screw through holes 39 for screwing the plate 30 to the rotor of the plate drive 50 are provided at, for example, four corners of the plate 30. The front surface of the plate 30 is irradiated with the laser light Lb from the irradiator 10. On the front surface of the plate 30, for example, a mark 35 formed by a guideline, a groove, or the like is provided so that the irradiation area RgN of the laser light Lb in the normal state can be seen. At least one through hole 33 through which a part of the laser light Lb from the irradiator 10 passes is provided at a position spaced apart from the rotation axis 30z in the plate 30. As shown in FIG. 3, a coating Ct for suppressing reflection of the laser light Lb is applied to the inner peripheral surface of the through hole 33. Specific aspects of the coating Ct include low temperature black chrome treatment. As shown in FIG. 10, in the normal state of the laser light Lb in the present embodiment, the optical axis LbZ coincides with the rotation axis 30z. The through hole 33 is disposed in the irradiation area RgN in the normal state.

Next, with reference to FIGS. 2 to 9, some specific aspects of the plate 30 will be illustrated.

A first plate 30a shown in FIGS. 2 and 3 has only one through hole 33a as the through hole 33. The through hole 33a has a circular cross-sectional shape when viewed in the plate normal direction.

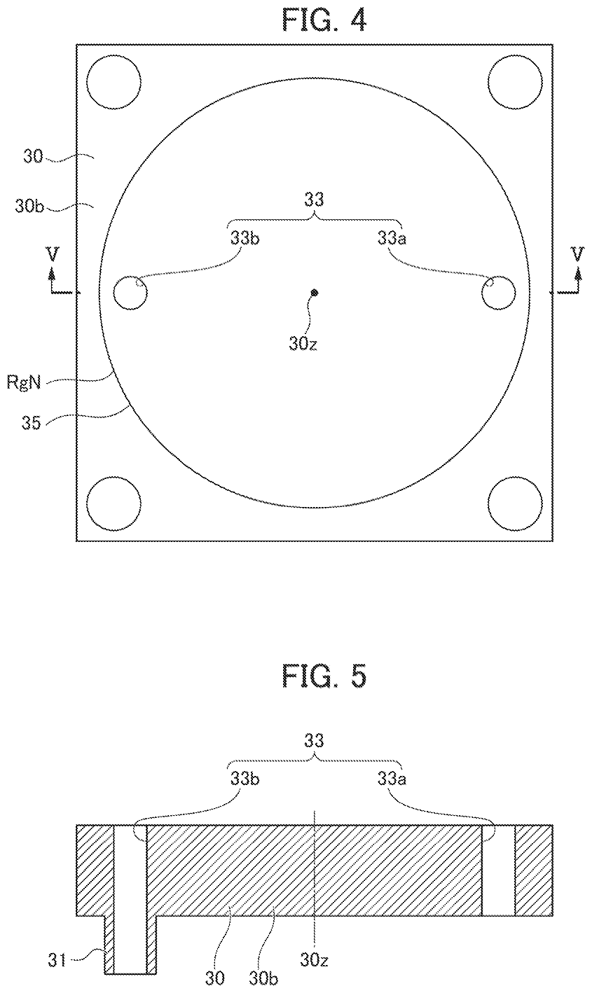

A second plate 30b shown in FIGS. 4 and 5 has the through hole 33a and a through hole 33b different from the through hole 33a as the through holes 33. The through hole 33b is provided, for example, at a position at an angle of 180° from the through hole 33a around the rotation axis 30z. The length of the through hole 33b in the penetrating direction is longer than the length of the through hole 33a in the penetrating direction. Specifically, a protrusion 31 protruding in the penetrating direction is provided around the through hole 33b on the back surface of the second plate 30b. Thereby, the through hole 33b is longer than the through hole 33a in the penetrating direction.

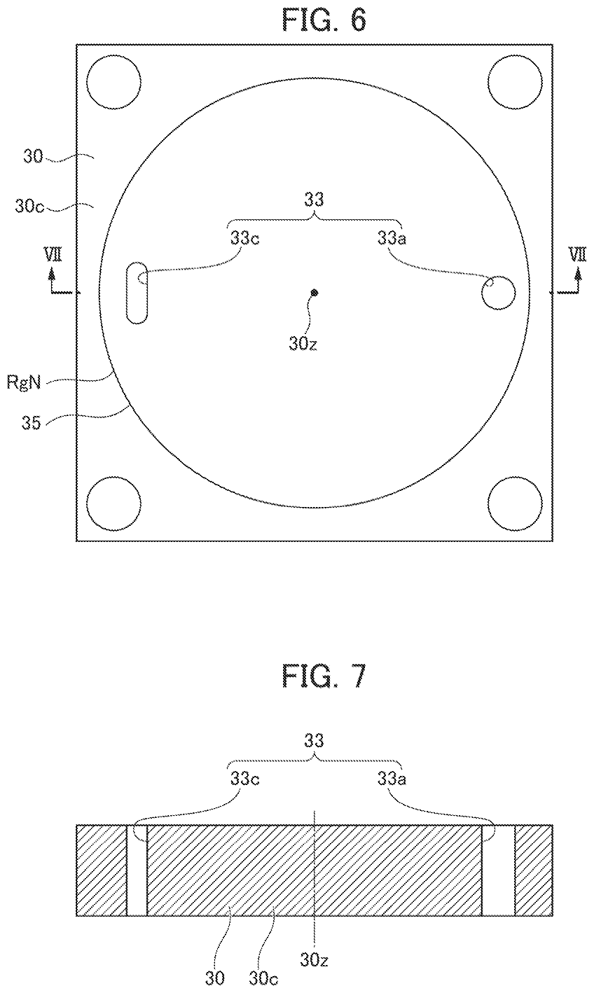

A third plate 30c shown in FIGS. 6 and 7 has the through hole 33a and a through hole 33c different from the through hole 33a as the through holes 33. Hereinafter, two directions of the plate 30 orthogonal to each other when viewed in the plate normal direction are referred to as a “longitudinal direction” and a “lateral direction”. The through hole 33c has an elliptical cross-sectional shape when viewed in the plate normal direction, and the length in the longitudinal direction and the length in the lateral direction are different from each other. The ellipse here is an ellipse in a broad sense, and includes an ellipse in a narrow sense, i.e., an ellipse in a mathematical definition In addition the ellipse here includes an oval shape, an intermediate shape between the oval shape and the ellipse in a narrow sense, and the like. Alternatively, the through hole 33c may have a rectangular cross-sectional shape instead of such an elliptical shape.

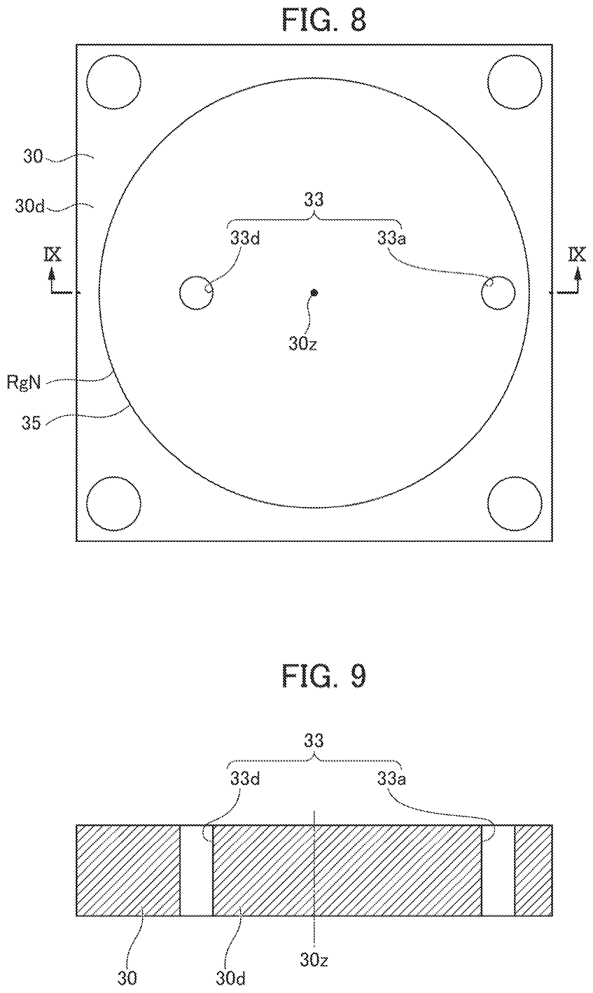

A fourth plate 30d shown in FIGS. 8 and 9 has the through hole 33a and a through hole 33d different from the through hole 33a as the through holes 33. The through hole 33d is provided at a position closer to the rotation axis 30z than the through hole 33a.

Next, with reference to FIG. 1 again, the plate drive 50, the meter 70, and the transition detector 80 will be described.

One of the plurality of plates 30 as exemplified above, that is, the plurality of plates 30 that differ from each other in at least one of the penetrating direction length, shape, or number of the through holes 33, is replaceably attached to the rotor of the plate drive 50.

Hereinafter, the laser light Lb that has passed through the through hole 33 is referred to as a “passing laser light LbP”. Hereinafter, the amount of light of the passing laser light LbP is referred to as a “passing laser amount”. However, instead of this, the amount of heat of the laser light Lb that has passed through may be the “passing laser amount”.

The meter 70 is provided below the plate 30 and measures the passing laser amount. Hereinafter, the measured value of the passing laser amount by the meter 70 is simply referred to as a “measured value LbQ”. Based on the measured value LbQ, the presence or absence of deviation of the laser light Lb from the normal state is determined. The plate drive 50 rotates the plate 30 by rotating the rotor in a state where the plate 30 is irradiated with the laser light Lb from the irradiator 10. As a specific aspect of the plate drive 50, there is a hollow rotating stage in which the vicinity of the rotation axis 30z is hollow and the passing laser light LbP is not blocked.

The transition detector 80 detects the form and direction of deviation of the laser light Lb by detecting the transition of the measured value LbQ as the plate 30 rotates.

Next, with reference to FIGS. 10 to 24, various forms of deviation of the laser light Lb will be described.

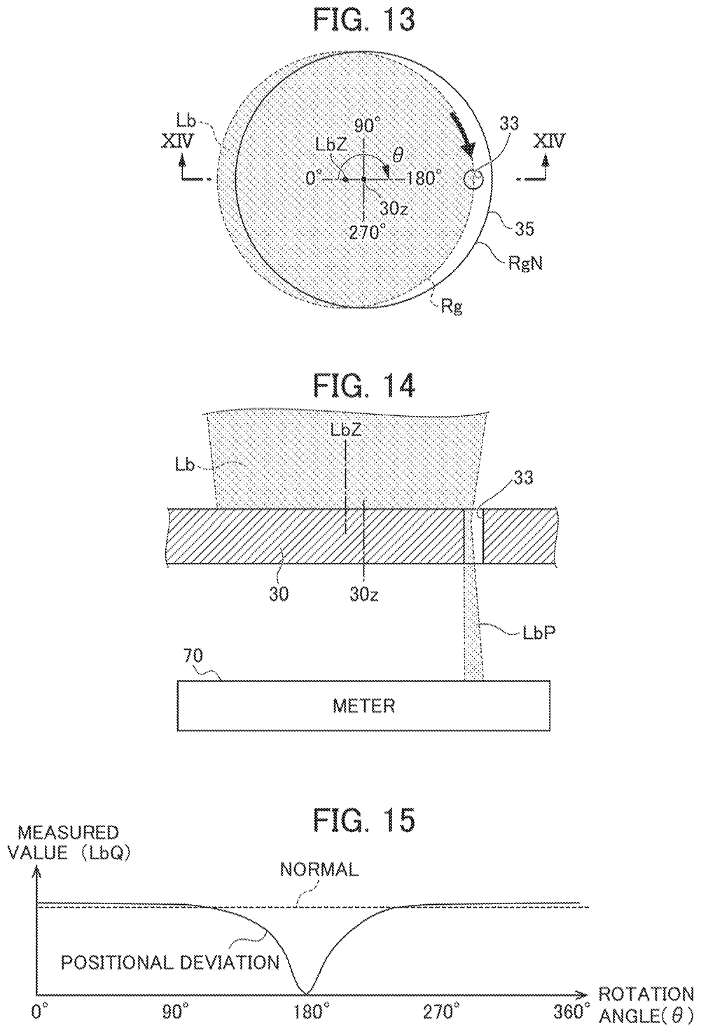

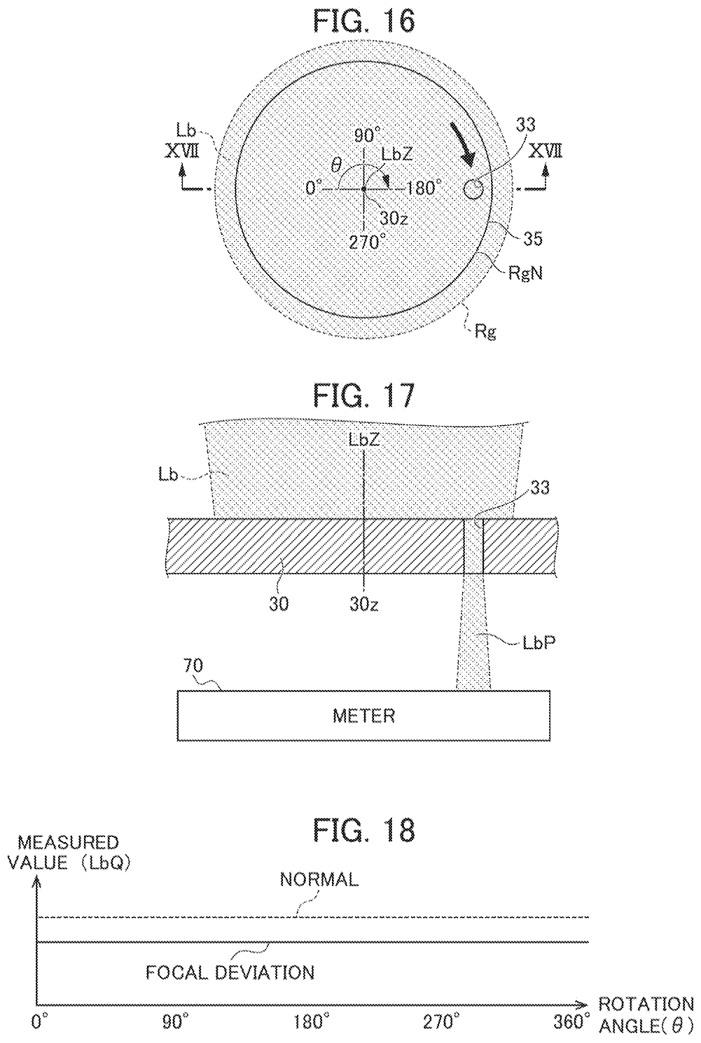

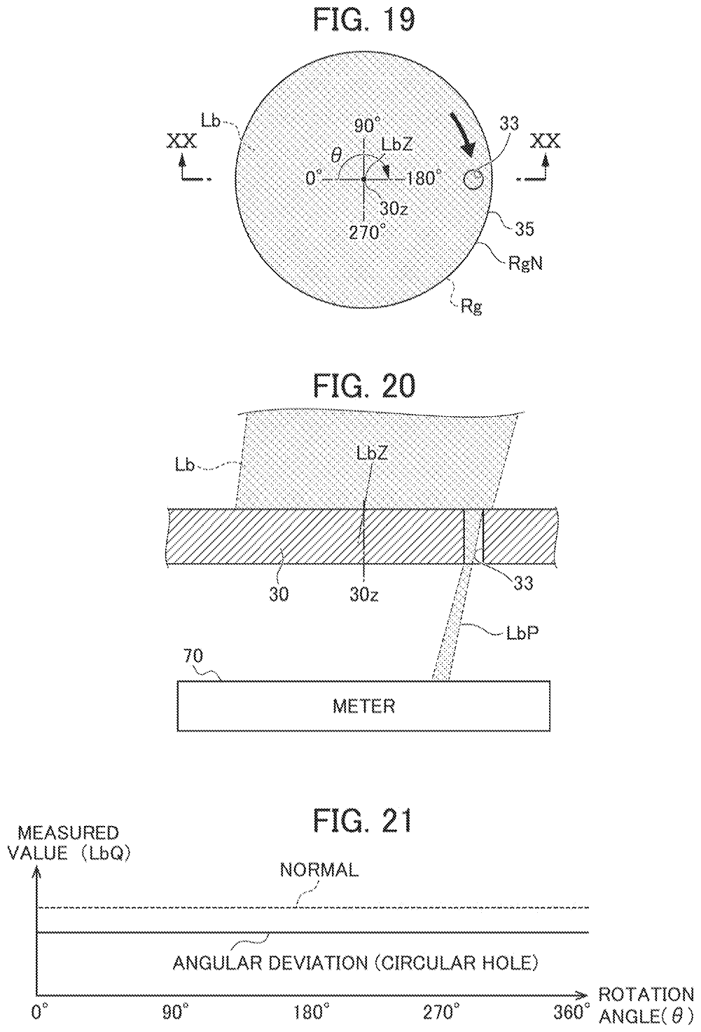

Hereinafter, as shown in FIGS. 13 and 14, the positional deviation of the irradiation area Rg from the irradiation area RgN in the normal state due to offset or the like is referred to as “positional deviation”. As shown in FIGS. 16 and 17, the deviation of the focal point of the laser light Lb from the normal state is referred to as “focal deviation”. As shown in FIGS. 19 and 20, the inclination of the optical axis LbZ from the normal state is referred to as “angular deviation”, and the direction of the inclined side is referred to as an “inclination direction”.

First, with reference to FIGS. 10 to 12, the normal state of the laser light Lb will be described. As described above, as shown in FIG. 10, the through hole 33 is disposed in the irradiation area Rg. Thus, as shown in FIG. 11, the laser light Lb having a predetermined amount of light passes through the through hole 33 and is measured as a predetermined measured value LbQ by the meter 70. In this state, the plate 30 rotates. At this time, since the optical axis LbZ coincides with the rotation axis 30z, the measured value LbQ does not change as the plate 30 rotates. Therefore, as shown in FIG. 12, the measured value LbQ becomes constant.

Next, with reference to FIGS. 13 to 15, a state in which the laser light Lb is positionally deviated will be described. In this case, as shown in FIGS. 13 and 14, the optical axis LbZ deviates from the rotation axis 30z due to the positional deviation. Incidentally, the density of the light in the irradiation area Rg is normally distributed in the diameter direction, and the density of the amount of light decreases toward the edge. Therefore, the measured value LbQ becomes largest at the rotation angle θ at which the through hole 33 is closest to the optical axis LbZ, that is, at 0° in FIG. 13, whereas the measured value LbQ becomes smallest at the rotation angle θ at which the through hole 33 is most distant from the optical axis LbZ, that is, at 180° in FIG. 13. In addition, at and near the 180° position, a part of the through hole 33 extends out of the irradiation area Rg, and the measured value LbQ becomes extremely small. Therefore, as shown in FIG. 15, the measured value LbQ changes as the plate 30 rotates.

Based on the transition of the measured value LbQ based on the above-described events, the transition detector 80 detects the direction of the positional deviation of the irradiation area Rg from the normal state. In other words, in the case of FIG. 13, the transition detector 80 determines a direction (0°) opposite to the rotation angle (180°), by 180°, at which the measured value LbQ becomes the smallest, as the direction of positional deviation.

Next, with reference to FIGS. 16 to 18, a state in which the laser light Lb is focally deviated will be described. In this case, as shown in FIGS. 16 and 17, due to the focal deviation, the range of the irradiation area Rg becomes larger than the range of the irradiation area RgN in the normal state. Thereby, the density of the light in the range of the irradiation area Rg becomes lower as a whole. Thereby, the measured value LbQ becomes smaller than that in the normal state. At this time, since the optical axis LbZ coincides with the rotation axis 30z, the measured value LbQ does not change as the plate 30 rotates. Therefore, as shown by a solid line in FIG. 18, the measured value LbQ becomes a constant value smaller than that in the normal state.

Using the above-described event, the transition detector 80 determines that the laser light Lb is focally deviated. That is, the transition detector 80 determines that the laser light Lb is focally deviated on a condition that the measured value LbQ deviates from the normal state and the change in the measured value LbQ as the plate 30 rotates is equal to or less than a predetermined value.

Next, with reference to FIGS. 19 to 21, a state in which the laser light Lb is angularly deviated when the cross-sectional shape of the through hole 33 is circular when viewed in the plate normal direction will be described. In this case, at least a part of the laser light Lb entering the through hole 33 interferes with the inner peripheral surface of the through hole 33. At this time, as described above, since the coating Ct for suppressing reflection is applied to the inner peripheral surface, most of the laser light Lb interfering with the inner peripheral surface is absorbed by the inner peripheral surface without being reflected. Thereby, the passing laser light LbP decreases as compared with the normal state, and the measured value LbQ decreases. At this time, since the optical axis LbZ coincides with the rotation axis 30z, the measured value LbQ does not change as the plate 30 rotates. Therefore, as shown by a solid line in FIG. 21, the measured value LbQ becomes a constant value smaller than that in the normal state.

Using the above-described event, the transition detector 80 determines that the laser light Lb is angularly deviated. In other words, the transition detector 80 determines that the laser light Lb is angularly deviated on a condition that the measured value LbQ deviates from the normal state and the change in the measured value LbQ as the plate 30 rotates is equal to or less than a predetermined value.

However, in this case, since FIGS. 18 and 21 are similar graphs, a problem may arise in that it is impossible to distinguish between a focal deviation and an angular deviation. To address this, for example, the plate 30 is replaced to change the length of the through hole 33 in the penetrating direction.

In the case of angular deviation, the direction of the optical axis LbZ deviates from the penetrating direction of the through hole 33. Therefore, in the case where the length of the through hole 33 in the penetrating direction is long, the interference of the laser light Lb with the inner peripheral surface of the through hole 33 is greater as compared with the case where the length of the through hole 33 in the penetrating direction is short, resulting in a decrease in the passing laser amount. On the other hand, in the case where the length of the through hole 33 in the penetrating direction is short, the interference of the laser light Lb with the inner peripheral surface of the through hole 33 is lower as compared with the case where the length of the through hole 33 in the penetrating direction is long, resulting in an increase in the passing laser amount. In other words, in the case of the angular deviation, if the length of the through hole 33 in the penetrating direction differs, the passing laser amount changes. On the other hand, in the case of the focal deviation, the direction of the optical axis LbZ coincides with the penetrating direction of the through hole 33. Therefore, even if the length of the through hole 33 in the penetrating direction differs, the passing laser amount is not significantly affected.

Using the above-described events, the transition detector 80 determines whether it is an angular deviation or a focal deviation. That is, the transition detector 80 determines that it is an angular deviation on the additional condition that the difference between measured values LbQ when the lengths of the through holes 33 in the penetration direction are different is greater than or equal to a predetermined value, and that it is a focal deviation on the additional condition that the difference is less than the predetermined value.

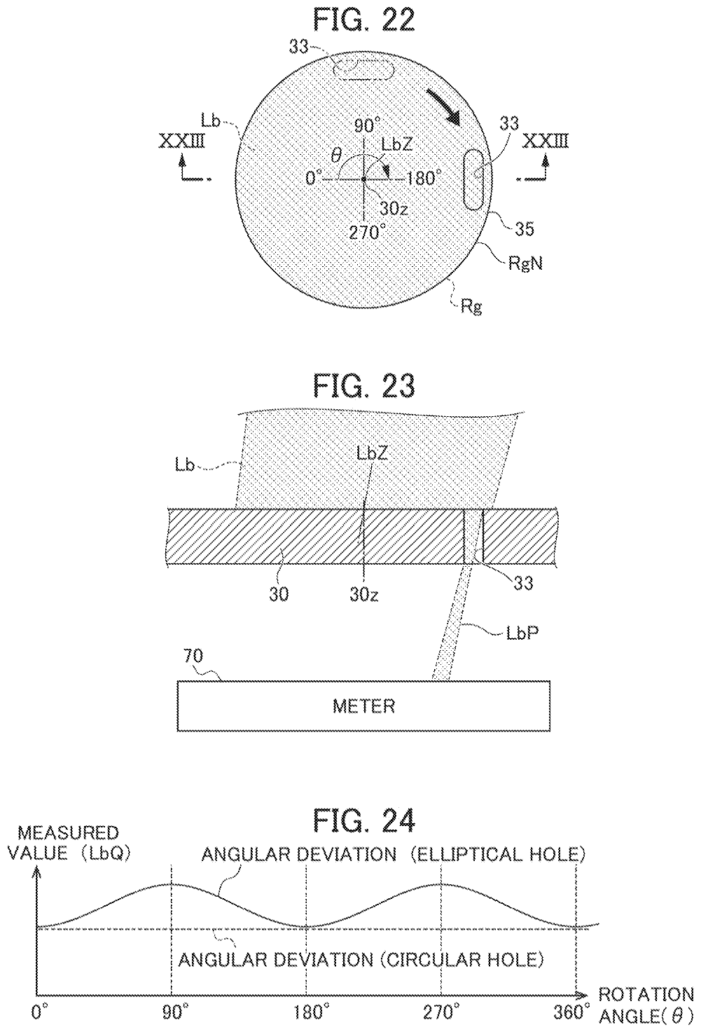

Next, with reference to FIGS. 22 to 24, a state in which the laser light Lb is angularly deviated when the cross-sectional shape of the through hole 33 is elliptical when viewed in the plate normal direction will be described. Note that the ellipse here is, as described above, an ellipse in a broad sense and includes an oval and the like. In this case, at least a part of the laser light Lb entering the through hole 33 interferes with the inner peripheral surface of the through hole 33. In particular, at rotation angles at which the inclination direction of the optical axis LbZ coincides with the minor axis direction of the ellipse, that is, at 0° and 180° in FIG. 22, the interference becomes large, and the measured value LbQ becomes small. On the other hand, at rotation angles at which the inclination direction of the optical axis LbZ coincides with the major axis direction of the ellipse, that is, at 90° and 270° in FIG. 22, the interference is suppressed compared to the rotation angles at which the inclination direction of the optical axis LbZ coincides with the minor axis direction of the ellipse. Thus, as shown in FIG. 24, the measured value LbQ changes in a wave shape as the plate 30 rotates.

Based on the transition of the measured value LbQ based on the above events, the transition detector 80 detects the inclination direction of the optical axis LbZ from the normal state. In other words, in the case of FIG. 22, the transition detector 80 determines that the optical axis LbZ is inclined to either side of the rotation angles (0°, 180°) at which the measured value LbQ becomes the smallest.

The features and effects of the present embodiment are summarized below.

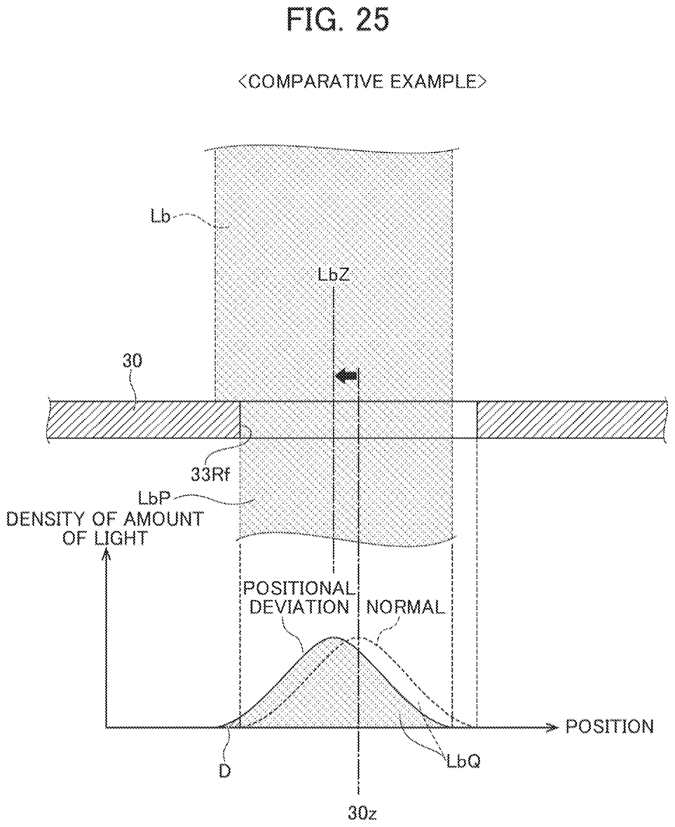

As described above, the density of the light in the irradiation area Rg is normally distributed in the diameter direction. Therefore, the density of the light decreases toward the edge of the irradiation area Rg. Therefore, as shown in FIG. 25, when a through hole 33Rf having the same size as the irradiation area RgN in the normal state is provided in the plate 30, even if the laser light Lb interferes with the edge of the through hole 33Rf due to the positional deviation of the irradiation area Rg, the ratio of a decrease D in the measured value LbQ in the normal state is small. Therefore, it is difficult to detect a minute deviation of the laser light Lb.

In this regard, in the present embodiment, as shown in

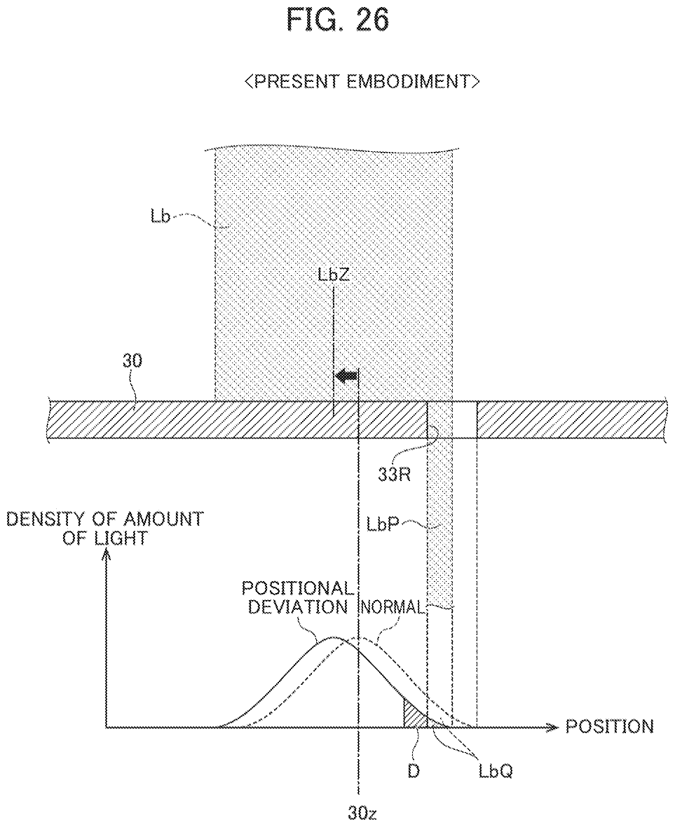

FIG. 1, the through hole 33 allows only a part of the laser light Lb from the irradiator 10 to pass therethrough. Therefore, as shown in FIG. 26, when the irradiation area Rg is positionally deviated due to offset or the like, the ratio of the decrease D in the measured value LbQ in the normal state is large. Therefore, the measured value LbQ tends to change significantly, and even a minute deviation of the laser light Lb can be easily detected.

In addition, the transition detector 80 detects the transition of the measured value LbQ as the plate 30 rotates. From this transition, it can be estimated whether the laser light Lb is deviated in any of forms such as a positional deviation, an angular deviation, and a focal deviation, and in which direction the laser light Lb is deviated.

As shown in FIGS. 2 to 9, one of the plurality of plates 30 that differ from each other in at least one of the penetrating direction length, shape, or number of the through holes 33 is replaceably provided to the plate drive 50. Therefore, by replacing the plate 30, it becomes easier to understand the form and direction of the deviation of the laser light Lb in more detail.

As shown in FIGS. 4 to 9, in a predetermined plate 30, a plurality of through holes 33 different from each other in at least one of the penetrating direction length, shape, or distance from the rotation axis 30z are formed as the through holes 33. Thus, without replacing the plate 30, it is possible to understand in detail the form and direction of the deviation of the laser light Lb.

As shown in FIG. 3, the coating Ct for suppressing reflection of the laser light Lb is applied to the inner peripheral surface of the through hole 33. Therefore, it is possible to suppress the laser light Lb interfering with the inner peripheral surface of the through hole 33 from being reflected and passing through the through hole 33. This allows a minute deviation of the laser light Lb to be understood more accurately.

As shown in FIGS. 13 to 15, in the case of positional deviation, the measured value LbQ becomes the largest at the rotation angle θ at which the through hole 33 is closest to the optical axis LbZ, and the measured value LbQ becomes the smallest at the rotation angle θ at which the through hole 33 is the most distant from the optical axis LbZ. Based on the transition of the measured value LbQ based on these events, the transition detector 80 can detect the direction of the positional deviation.

As shown in FIGS. 16 to 18, in the case of focal deviation, although the measured value LbQ deviates from the normal state, the measured value LbQ does not change as the plate 30 rotates. Using these events, the transition detector 80 can determine that the laser light Lb is focally deviated on condition that the measured value LbQ deviates from the normal state and the change in the measured value LbQ as the plate 30 rotates is equal to or less than a predetermined value.

In the case of the angular deviation shown in FIGS. 19 and 20, when the length of the through hole 33 in the penetrating direction is different, the passing laser amount changes. On the other hand, in the case of the focal deviation shown in FIGS. 16 and 17, even if the length of the through hole 33 in the penetrating direction is different, the passing laser amount is not significantly affected. Using these events, the transition detector 80 can determine that the laser light Lb is angularly deviated on condition that the difference between the measured values LbQ in the case where the lengths of the through holes 33 in the penetration direction are different is equal to or greater than a predetermined value.

As shown in FIGS. 22 to 24, in the case of angular deviation, when the cross-sectional shape of the through hole 33 is an ellipse, the following is obtained. That is, at the rotation angles θ at which the inclination direction of the laser light Lb coincides with the shorter direction of the through hole 33, the passing laser amount is smaller than that at the rotation angles θ at which the inclination direction of the laser light Lb coincides with the longer direction. On the other hand, at the rotation angles θ at which the inclination direction of the laser light Lb coincides with the longer direction of the through hole 33, the passing laser amount is larger than that at the rotation angles θ at which the inclination direction of the laser light Lb coincides with the shorter direction. Based on the transition of the measured value LbQ based on these events, the transition detector 80 can detect the inclination direction of the optical axis LbZ from the normal state.

### Other Embodiments

The embodiment described above can be modified as follows, for example. In the first embodiment, as shown in FIG. 2, etc., the entire through hole 33 is disposed in the irradiation area RgN in the normal state, but only a part of the through hole 33 may be disposed in the irradiation area RgN in the normal state. In the first embodiment, the optical axis LbZ in the normal state coincides with the rotation axis 30z of the plate 30, but the optical axis LbZ in the normal state may be intentionally deviated from the rotation axis 30z.

In the first embodiment, the mark 35 such as a guideline or a groove is provided on the plate 30 in order to see the irradiation area RgN in the normal state, the mark 35 may be omitted if the mark 35 is unnecessary. Specifically, for example, the mark 35 may be omitted by making the plate 30 circular and the edge of the circular plate 30 exactly overlap with the edge of the irradiation area RgN in the normal state. Further, for example, when visual confirmation of the irradiation area Rg is completely unnecessary, the mark 35 can be omitted.

### EXPLANATION OF REFERENCE NUMERALS

10 irradiator
30 plate
30z rotation axis
33 through hole
50 plate drive
70 meter
80 transition detector
100 laser machining apparatus
Ct coating
Lb laser light
LbQ measured value of passing laser amount
LbZ optical axis of laser light
Rg irradiation area of laser light
RgN irradiation area of laser light in normal state

What is claimed is:

1. A laser machining apparatus, comprising:
an irradiator configured to emit laser light;
a plate configured to be rotatable about a predetermined rotation axis and be irradiated with the laser light, the plate comprising a through hole at a position spaced apart from the rotation axis, at least a part of the through hole being included in an irradiation area of the laser light in a predetermined normal state, the through hole allowing a part of the laser light to pass therethrough;
a meter configured to measure a passing laser amount as an amount of light or an amount of heat of the laser light passing through the through hole;
a plate drive configured to rotate the plate in a state where the plate is irradiated with the laser light; and
a transition detector configured to detect a transition of a measured value of the passing laser amount as the plate rotates.

2. The laser machining apparatus according to claim 1, wherein one of a plurality of the plates different from each other in at least one of penetrating direction length, shape, or number of the through holes is replaceably provided to the plate drive.

3. The laser machining apparatus according to claim 1, wherein the plate comprises a plurality of the through holes different from each other in at least one of penetrating direction length, shape, or distance from the rotation axis.

4. The laser machining apparatus according to claim 1, wherein a coating for suppressing reflection of the laser light is applied to an inner peripheral surface of the through hole.

5. The laser machining apparatus according to claim 1, wherein the transition detector detects a direction of positional deviation of the irradiation area from the normal state based on the transition of the measured value.

6. The laser machining apparatus according to claim 1, wherein the transition detector determines that a focal point of the laser light deviates from the normal state on condition that the measured value deviates from the normal state and a change in the measured value as the plate rotates is equal to or less than a predetermined value.

7. The laser machining apparatus according to claim 1, wherein the transition detector determines that an angle of an optical axis of the laser light deviates from the normal state on condition that a difference between the measured values when penetrating direction lengths of the through holes are different is equal to or greater than a predetermined value.

8. The laser machining apparatus according to claim 1,
wherein the plate comprises the through hole having a length in a predetermined longitudinal direction and a length in a lateral direction orthogonal to the longitudinal direction different from each other when viewed in a direction perpendicular to a surface of the plate, and
wherein the transition detector detects a direction of inclination of an optical axis of the laser light from the normal state based on the transition of the measured value.
